(19) United States
(12) Patent Application Publication
(10) Pub. No.: US 2024/0416345 A1
(43) Pub. Date: Dec. 19, 2024

(54) METHODS AND DEVICES FOR CELL COUNTING AND ANALYSIS

(71) Applicant: WAINAMICS, INC., Pleasanton, CA (US)

(72) Inventors: Ming Xiao Tan, San Ramon, CA (US); Huyen Tran, San Jose, CA (US); Jonathan Diver, San Jose, CA (US)

(21) Appl. No.: 18/702,705

(22) PCT Filed: Nov. 1, 2022
(86) PCT No.: PCT/US2022/048540

§ 371 Date: Apr. 18, 2024

Related U.S. Application Data
(60) Provisional application No. 63/276,897, filed on Nov. 8, 2021.

(51) Int. Cl. B01L 3/00; G01N 15/10; G01N 15/14

(52) U.S. Cl. CPC B01L 3/502761; B01L 3/502715; G01N 15/1484; B01L 2200/0652; B01L 2400/0672; G01N 2015/1006; G01N 2015/1486

(57) ABSTRACT

The invention provides microfluidics devices, methods and kits employing expandable gels in a sample chamber for translocating cells or particles in a sample solution to an observation plane to facilitate counting and analysis.

Practical challenges of determining concentrations of biological cells includes defining a volume in which cell types are counted, identifying cell types and correcting for, or avoiding, interference or obstruction of some cells by others, particularly when such measurements require instrumentation, such as microscopes. Identifying cell types may require detection of specialized labels, such as labeled antibodies bound to identifying proteins, and/or monitoring behaviors or movements of live cells. Solutions to these challenges include the use of sample chambers with precise dimensions to match the size of the objects to be detected, accumulating data from a succession of small imaged fields, employing costly optical sectioning methods, and the like, e.g. Obrien et al, U.S. Pat. No. 10,132,738; Goldberg, U.S. Pat. No. 8,248,597; Chang et al, U.S. Pat. No. 7,411,680; Wardlaw, U.S. Pat. No. 6,723,290; Conchello et al, Nature Methods, 2(12): 920-931 (2005); and the like.

Methods of particle and cell counting and analysis would be advanced by the availability of an inexpensive and flexible device for enhancing image-based methods for detecting and analyzing particles and cells.

### SUMMARY OF THE INVENTION

The invention is directed to apparatus, methods and kits for counting and analyzing particles, such as, biological cells. In one aspect, the invention relates to the use of expandable hydrogels to move such particles or biological cells from a sample into a predetermined planar region to facilitate imaging and detection. In some embodiments, an expandable hydrogel may also be used to immobilize, orient or compress such particles or biological cells in the predetermined planar region.

In some aspects, the invention is directed to a microfluidic device for cell counting, imaging and analysis comprising the following elements: (a) a sample inlet; (b) a sample chamber having an interior in communication with the sample inlet, the sample chamber having a first wall and a second wall opposite the first wall, the first wall being optically transmissive; and (c) an expandable gel disposed on the second wall capable of expanding to fill the interior of the chamber so that whenever the expandable gel is exposed to a sample solution the expandable gel expands towards the first wall forcing cells in the sample solution into an observation plane adjacent to, and substantially parallel with, the first wall. In some embodiments, cells of interest in a sample solution have an average size and the expandable gel has an average pore size less than the average size of said cells to be counted or analyzed during and after expansion.

In some aspects, the present invention overcomes challenges in the art of optical counting and analysis of cells by providing a means using an expandable gel for constraining cells or particles to an observation plane that coincides with and/or overlaps a focal plane of a light collection lens, such as an objective lens, that produces an image thereof for counting and analysis. In some embodiments, such constraining comprises orienting non-spherical cells (such as, disk-shaped, oblate spheroidal, flat, or the like) so that the largest profile of the cells is exposed to optical analysis. In some embodiments, such constraining comprises flattening a spheroidal cell so as to present a larger profile for analysis and to provide a clearer view of the nucleus and cellular organelles.

These above-characterized aspects, as well as other aspects, of the present invention are exemplified in a number of illustrated implementations and applications, some of which are shown in the figures and characterized in the claims section that follows. However, the above summary is not intended to describe each illustrated embodiment or every implementation of the present invention.

### BRIEF DESCRIPTION OF THE DRAWINGS

FIGS. 1A-1G illustrate the operation of one embodiment of the invention.

### DETAILED DESCRIPTION OF THE INVENTION

The general principles of the invention are disclosed in more detail herein particularly by way of examples, such as those shown in the drawings and described in detail. It should be understood, however, that the intention is not to limit the invention to the particular embodiments described. The invention is amenable to various modifications and alternative forms, specifics of which are shown for several embodiments. The intention is to cover all modifications, equivalents, and alternatives falling within the principles and scope of the invention.

The invention is directed to microfluidic devices for counting, imaging and analyzing biological cells or particles which employ an expandable gel to translocate cells or particles in a sample solution to an observation plane to facilitate detection and enumeration. The invention also is directed to methods and kits employing microfluidic devices of the invention. In some embodiments, microfluidic devices of the invention may comprise components for labeling or otherwise modifying sample constituents, which may then be detected and analyzed in accordance with methods of the invention and conventional microscopic analysis. Examples of such components are described in Bornheimer et al. U.S. Pat. Nos. 9,797,899 and 10,073,093; and Goldberg, U.S. Pat. No. 8,248,597, which patents are incorporated herein by reference.

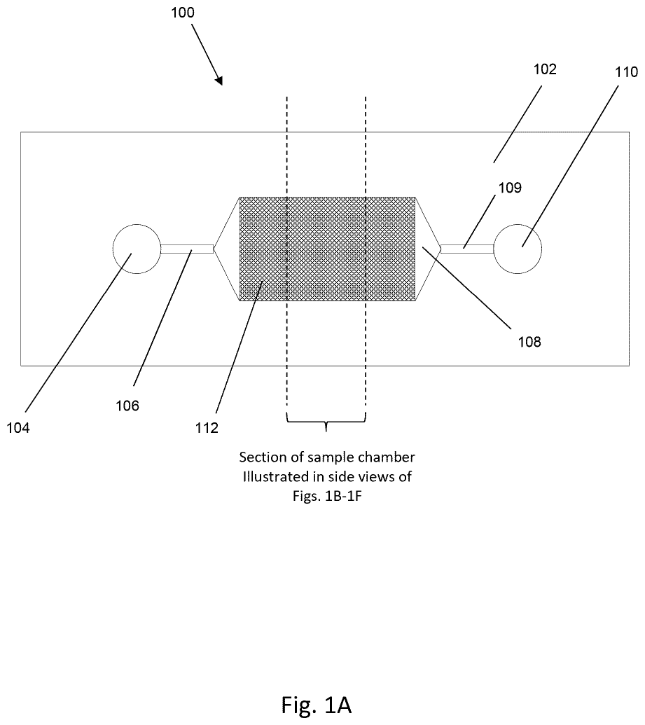

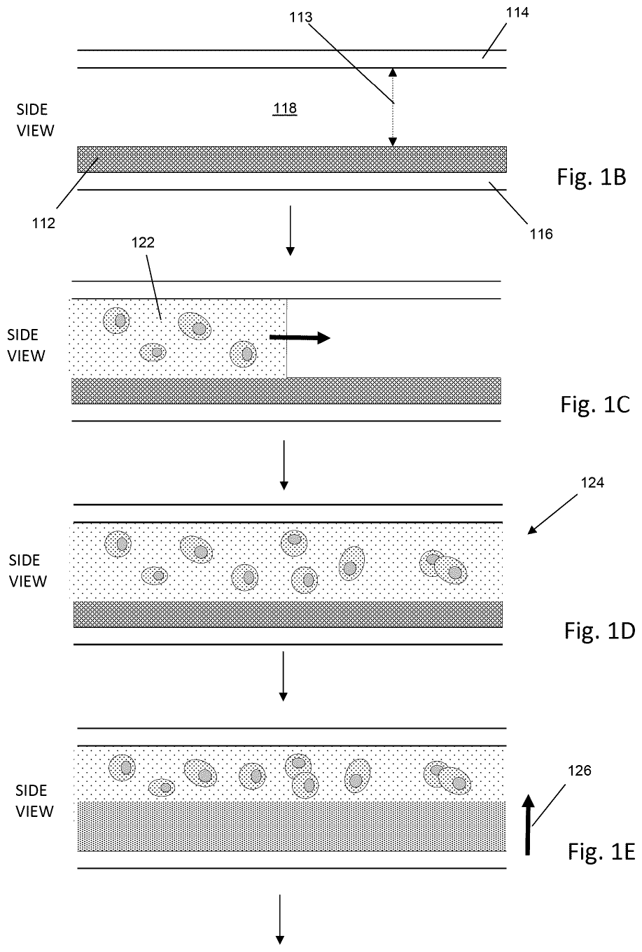

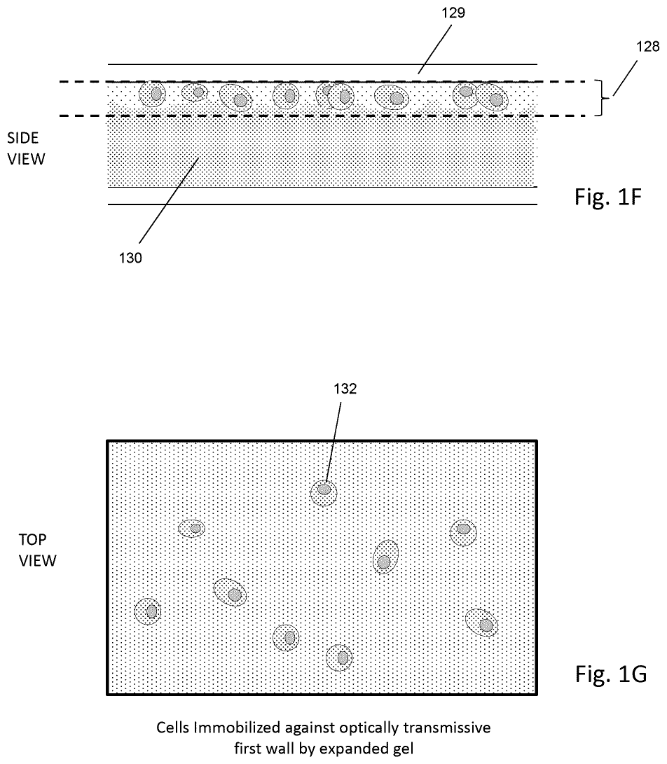

FIGS. 1A-1G illustrate the operation of an exemplary embodiment of the invention. Exemplary microfluidic device (100) may have the dimensions of a standard microscope slide and may comprise plastic or glass or like material (102). In some embodiments, a known volume of sample or sample solution (i.e. a sample mixed with other fluids, e.g. saline buffers, to form a known or predetermined volume) is inserted into inlet (104), travels through passage (106) into sample chamber (108). In some embodiments, sample chamber (108) is designed to accept a volume of sample solution in the range of from 5 μL to 250 μL. In some embodiments, sample chamber (108) may have a vertical dimension (e.g. along an optical axis of a detection system used with the invention) in the range of greater than 50 μm, in the range of from 50 μm to 10 mm, or from 50 μm to 1 mm. The area of sample chamber (108) (i.e. dimensions perpendicular to the vertical dimension) may vary widely. In some embodiments, sample chamber (108) may have an area in the range of from 0.1 mm² to 1000 mm², or from 1 mm² to 100 mm². Excess sample solution may enter passage (109) and vent port (110). In the interior of sample chamber (108) expandable gel (112) in a contracted state is disposed on second wall (116) so that there is empty space (118) for a sample solution to occupy after insertion. Usually, the vertical distance (113) between the top of expandable gel (112) and wall (114) is greater than 50 μm, or greater than 100 μm, to reduce the likelihood of clogging of the chamber when loading sample solutions containing cells and/or other materials. A sample solution may be driven into space (118) by capillary action or by pressure or vacuum using conventional microfluidic techniques. As shown in FIG. 1C, sample solution (122) flows into and occupies (124) space (118) above expandable gel (112) after which device (100) is incubated to allow expandable gel (112) to expand (126). Such incubation may include changing physical conditions of microfluidic device (100) or sample chamber (108), e.g. by elevating temperature, or the like, in order to implement or enhance expansion of expandable gel (112). In some embodiments, e.g. using desiccated hydrogels as expandable gels, only exposure to a sample solution is required for the expandable gel to expand in accordance with the invention. The length of incubation may depend on the nature and thickness of expandable gel (112). In some embodiments, expandable gel (112) is a desiccated hydrogel which is formulated and sized so that an incubation time is in the range of from 5-10 minutes, or in the range of from 2-20 minutes. As shown in FIG. 1F, at the end of the incubation period, expandable gel (130) has expanded and translocated cells in the sample solution to observation plane (128) adjacent to, and parallel with, first wall (129) which is transparent or optically transmissive to permit detection of light or optical signals by optical sensors outside of microfluidics device (100). Usually observation plane is 50 μm or less and overlaps a focal plane of the optical system employed for image collection. For such translocation to occur for particles of cell types of interest, expandable gel (112) is formulated to have average pore diameters, both in its contracted state and its expanded state, less than the average diameter or size of the particles or cells of interest. In some embodiments, expandable gel (112) is formulated to have average pore diameters, both in its contracted state and its expanded state, less than half the average diameter or size of the particles or cells of interest. In still other embodiments, expandable gel (112) is formulated to have average pore diameters, both in its contracted state and its expanded state, less than one tenth of the average diameter or size of the particles or cells of interest. Observation plane (128) may be determined by a selection of the objective lens of an optical detection system used with the invention. Conventional optical detection systems may be employed with the invention, such as described in Chang et al, U.S. Pat. No. 7,411,680, or Goldberg, U.S. Pat. No. 8,248,597, which are incorporated herein by reference. In some embodiments, an objective lens may be selected which has a magnification in a range of from 4× to 202×, or from 4× to 100×, or from 4× to 20×. Alternatively, an objective lens may be selected which has a depth of field in the range of from 2 μm to 20 μm, which depth of field coincides with, or overlaps, observation plane (128). In some embodiments, an optical system employed with the invention has a depth of field in the range of from 2 μm to 10 μm. After the incubation period during which the expandable gel expands, cells or particles of interest are projected or translocated to observation plane (128) where cells or particle may be detected and/or counted or analyzed, as illustrated in FIG. 1G. Cell or particle concentrations may be determined by tabulating cell or particle numbers in one or more optical detection fields, the size of which depends on the optical detection system employed. The number in each field corresponds to the number in the volume determined by the area of the field times the depth of space (118) above expandable gel (112) in its contracted state. The accuracy of the determined concentration may be increased by taking counts from an increased number of fields.

While FIG. 1G suggest that cells to be analyzed or counted (132) are stationary, in some embodiments, measurements may be made on living cells, so that cell motility may be a characteristic of interest that is measured, e.g. by taking multiple images of the cells in observation plane (128).

### Manufacture of Microfluidic Devices of the Invention

Body (e.g. 102, FIG. 1A) of device (100) may comprise a variety of components, such as, chambers and passages, which may be formed in, a wide variety of materials well-known in the microfluidics field, such as, silicon, glass, plastic, or the like, e.g. Ren et al, Acc. Chem. Res., 46(11): 2396-2406 (2013). That is, devices of the invention may be fabricated as microfluidics devices using well-known techniques and methodologies of the microfluidic field. In some embodiments, body (102) may comprise a plastic, such as, polystyrene, polyethylenetetraphthalate glycol, polyethylene terephthalate, polymethylmethacrylate, polyvinylchloride, polycarbonate, cyclic olefin co polymer and cyclic olefin polymer, thermo plastic elastomer or the like. Devices of the invention may be fabricated with or in plastic using well-known techniques including, but not limited to, hot embossing, injection molding, laser cutting, milling, etching, 3D printing, or the like. Guidance in the selection of plastics and fabrication methodologies may be found in the following references: Becker et al, Talanta, 56: 267-287 (2002); Fiorini et al, Biotechniques, 38(3): 429-446 (2005); Bjornson et al, U.S. Pat. No. 6,803,019; Soane et al, U.S. Pat. No. 6,176,962; Schaevitz et al, U.S. Pat. No. 6,908,594; Neyer et al, U.S. Pat. No. 6,838,156; and the like. which references are incorporated herein by reference.

### Expandable Gels

A wide variety of expandable gels may be used with the invention. Important features are (i) that the expandable gel can expand in volume in response to a sample solution by a factor of two or more, and (ii) that it has an average pore diameter both in a contracted state and an expanded state (to the volume of the sample chamber) less than the average diameter of the cell types or particles of interest.

In some embodiments expandable gels for use with the invention are hydrogels which have been desiccated to form a contracted state. Hydrogels are three dimensional hydrophilic polymer networks that can swell and hold a large amount of water while maintaining their structure, which comprises a three dimensional network formed by crosslinking polymer chains, e.g. Chirani et al, J. Biomedical Sciences, 4(2): 13 (2015). Crosslinking can be provided by covalent bonds, hydrogen bonding, Van der Waals interactions or physical entanglements; in some embodiments, hydrogels used in the invention have covalently crosslinked polymer chains. Hydrogels employed in the invention undergo significant, and usually, reversible volume changes in response to external stimulus such as pH, temperature, ionic concentration, as well as in response to desiccation and hydration. In some embodiment, hydrogels used with the invention have the capability of expanding in volume from a desiccated state to a hydrated state by a factor of two or more, or by a factor of 5 or more, or by a factor of 10 or more.

In some embodiments, expandable hydrogels comprise poly(acrylamide)-based hydrogels, for example, as described in Qavi et al, J. Macromolecular Science, part A, 51: 842-848 (2014); Shah et al, J. Pharmaceutical Science and Bioscientific Research, 4(1): 114-120 (2014); which are incorporated by reference. In other embodiments, expandable hydrogels comprise synthetic polymers, such as, hydroxyl ethylmethacryate (HEMA), vinyl acetate (VAc), Acryolic acid (AA), N-(2-hydroxy propyl) methacrylate (HPMA), N-vinyl-2-pyrrolidone (NVP), N-isopropylacrylamide (NIPAMM), or the like. In other embodiments, expandable hydrogels comprise natural polymers, such as, agar, chitosan, gelatin, hyaluronic acid, alginate, fibrin, or the like, e.g. MacDougal et al, Bot. Gaz., 70: 126-136 (1920). In still other embodiments, hydrogels for use with the invention may be synthesized by cross-linking readymade water-soluble polymers. Water-soluble polymers such as poly(acrylic acid), poly(vinyl alcohol), poly(vinylpyrrolidone), poly(ethylene glycol), polyacrylamide and various polysaccharides may be employed in such synthesis, e.g. Calo et al, European Polymer Journal, 65: 252-267 (2015); U.S. Pat. No. 8,734,834; and the like. Hydrogels may also be photosynthesized using conventional methods, e.g. Lin et al, J. Appl. Polymer Sci., 41563(2015); Das et al, U.S. Pat. No. 9,561,622 (which is incorporated herein by reference): Pishko et al, U.S. patent publication 2003/0175824 (which is incorporated herein by reference); and the like. Porosity, including tortuosity and average pore size, may be determined by the degree of crosslinking and other techniques known in the art, e.g. Chirani et al (cited above); Harland et al “PolyelectrolyteGels: Properties, Preparation and Application.” American Chemical Society (1992); Annabi et al. Tissue Engineering, Part B, 16(4): 371-383(2010): Morrison F A. Understandin Rheology. Oxford University Press.

In some embodiments, expandable gels may comprise stains or labeling reagents that may combine with a sample solution to label or stain particles or cells. In some embodiments, labeling reagents comprise one or more labeled antibodies. In some embodiments, such antibodies are specific for one or more cell surface antigens. In some embodiments, such antibodies may be labeled with different fluorescent dyes.

Expandable hydrogels may be applied to sample chamber (108) of a disassembled microfluidics device (100) (FIG. 1A) in liquid form, after which it is desiccated to form contracted hydrogel (112). Components of microfluidic device are then assembled to give an operable device. Common assembly methods include, but are not limited to, thermal bonding, vapor bonding, laser welding, ultrasonic welding, pressure-sensitive adhesives, UV adhesives, thermal adhesives, and the like. In some embodiments, glass or plastic components of a microfluidic device in contact with a hydrogel (e.g. the sample chamber) may be treated to improve the adhesion of the hydrogel to surfaces of such components. In some embodiments, such components may be treated with a low pressure gas plasma, or like treatment, to make such surfaces more hydrophilic.

While the present invention has been described with reference to several particular example embodiments, those skilled in the art will recognize that many changes may be made thereto without departing from the spirit and scope of the present invention. The present invention is applicable to a variety of implementations in addition to those discussed above.

### Definitions

Generally, terms used herein not otherwise specifically defined have meanings corresponding to their conventional usage in the fields related to the invention, including analytical chemistry, biochemistry, molecular biology, cell biology, microscopy, image analysis, and the like, such as represented in the following treatises: Alberts et al, Molecular Biology of the Cell, Fourth Edition (Garland, 2002); Nelson and Cox, Lehninger Principles of Biochemistry, Fourth Edition (W. H. Freeman, 2004); Murphy, Fundamentals of Light Microscopy and Electronic Imaging (Wiley-Liss, 2001).

“Microfluidics device” means an integrated system of one or more chambers, ports, and channels that are interconnected and in fluid communication and designed for carrying out an analytical reaction or process, either alone or in cooperation with an appliance or instrument that provides support functions, such as sample introduction, fluid and/or reagent driving means, temperature control, detection systems, data collection and/or integration systems, and the like. Microfluidics devices may further include valves, pumps. and specialized functional coatings on interior walls, e.g., to prevent adsorption of sample components or reactants, facilitate reagent movement by electroosmosis, or the like. Such devices are usually fabricated in or as a solid substrate, which may be glass, plastic, or other solid polymeric materials, and typically have a planar format for ease of detecting and monitoring sample and reagent movement, especially via optical or electrochemical methods. Features of a microfluidic device usually have cross-sectional dimensions of less than a few hundred square micrometers and passages typically have capillary dimensions, e.g., having maximal cross-sectional dimensions of from about 500 μm to about 0.1 μm. Microfluidics devices typically have volume capacities in the range of from 1 μL to a fewer than 10 nL, e.g., 10-100 nL. The fabrication and operation of microfluidics devices are well-known in the art as exemplified by the following references that are incorporated by reference: Ramsey, U.S. Pat. Nos. 6,001,229; 5,858,195; 6,010,607; and 6,033,546; Soane et al, U.S. Pat. Nos. 5,126,022 and 6,054,034; Nelson et al, U.S. Pat. No. 6,613,525; Maher et al, U.S. Pat. No. 6,399,952; Ricco et al, International patent publication WO 02/24322; Bjornson et al, International patent publication WO 99/19717; Wilding et al, U.S. Pat. Nos. 5,587,128; 5,498,392; Sia et al, Electrophoresis, 24: 3563-3576 (2003); Unger et al, Science, 288: 113-116 (2000); Enzelberger et al, U.S. Pat. No. 6,960,437; Haeberle et al, LabChip, 7: 1094-1110 (2007); Cheng et al, Biochip Technology (CRC Press, 2001); and the like.

“Sample” means a quantity of material from a biological, environmental, medical, or patient source in which detection or measurement of predetermined cells, particles, beads, and/or analytes is sought. A sample may comprise material from natural sources or from man-made sources, such as, tissue cultures, fermentation cultures, bioreactors, and the like. Samples may comprise animal, including human, fluid, solid (e.g., stool) or tissue, as well as liquid and solid food and feed products and ingredients such as dairy items, vegetables, meat and meat by-products, and waste. Samples may include materials taken from a patient including, but not limited to cultures, blood, saliva, cerebral spinal fluid, pleural fluid, milk, lymph, sputum, semen, needle aspirates, and the like. Samples may be obtained from all of the various families of domestic animals, as well as feral or wild animals, including, but not limited to, such animals as ungulates, bear, fish, rodents, etc. Samples may include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention. In some embodiments, “sample” means a blood sample. In some embodiments, a blood sample may comprise a fraction of a whole blood sample, e.g. a component of a blood sample. In some embodiments, such component may be obtained by treating a whole blood sample with one or more selection or fractionation techniques. The terms “sample.” “biological sample,” and “specimen” are used interchangeably.

What is claimed is:

1. A microfluidic device for cell counting, imaging and analysis. the microfluidic device comprising:
a sample inlet;
a sample chamber having an interior in communication with the sample inlet, the sample chamber having a first wall and a second wall opposite the first wall, the first wall being optically transmissive;
an expandable gel disposed on the second wall capable of expanding to fill the interior of the chamber so that whenever the expandable gel is exposed to a sample solution the expandable gel expands towards the first wall forcing cells in the sample solution into an observation plane adjacent to, and substantially parallel with, the first wall.

2. The microfluidics device of claim 1 wherein said cells have an average size and wherein said expandable gel has an average pore size less than the average size of said cells to be counted or analyzed during and after expansion.

3. The microfluidics device of claim 2 wherein said average pore size is less than one half of said average cell size.

4. The microfluidics device of claim 2 wherein said expandable gel is a desiccated hydrogel.

5. The microfluidics device of claim 4 wherein said desiccated hydrogel comprises crosslinked polymers of poly(acrylic acid), poly(vinyl alcohol), poly(vinylpyrrolidone), poly(ethylene glycol), or polyacrylamide.

6. The microfluidic device of claim 4 wherein said desiccated hydrogel comprises agarose.

7. The microfluidics device of claim 1 wherein said observation plane adjacent to and substantially parallel with said first wall has a dimension perpendicular to said first wall in the range from 5 to 50 μm.

8. The microfluidic device of claim 1 wherein said cells are immobilized by said expandable gel in said observation plane whenever said expandable gel is exposed to said sample solution.

9. A method of cell counting and analysis, the method comprising the steps of:
providing microfluidic device comprising: (a) a sample inlet; (b) a sample chamber having an interior in communication with the sample inlet, the sample chamber having a first wall and a second wall opposite the first wall, the first wall being optically transmissive; and (c) an expandable gel disposed on the second wall capable of expanding to fill the interior of the chamber so that whenever the expandable gel is exposed to a sample solution the expandable gel expands towards the first wall forcing cells in the sample solution into an observation plane adjacent to, and substantially parallel with, the first wall;
loading a sample solution into the microfluidic device so that the expandable gel is immersed therein;
incubating the microfluidic device until the expandable gel expands to fill the interior of the sample chamber so that cells in the sample solution are forced into the observation plane;
illuminating the observation plane;
collecting light from the observation plane to form an image; and
analyzing cells in the image.

10. The method of claim 9 wherein said step of collecting comprising collecting said light with an objective lens having a magnification in the range of from 4× to 200×.

11. The method of claim 9 wherein said step of analyzing includes counting said cells in said image.

12. The method of claim 9 wherein said step of incubating comprises immobilizing said cells in said observation plane.

13. A kit for counting or analyzing cells or particles, the kit comprising:
a microfluidic device comprising: (a) a sample inlet; (b) a sample chamber having an interior in communication with the sample inlet, the sample chamber having a first wall and a second wall opposite the first wall, the first wall being optically transmissive; and (c) an expandable gel disposed on the second wall capable of expanding to fill the interior of the chamber so that whenever the expandable gel is exposed to a sample solution the expandable gel expands towards the first wall forcing cells in the sample solution into an observation plane adjacent to, and substantially parallel with, the first wall.

14. The kit of claim 13 wherein said expandable gel is a desiccated hydrogel.

15. The kit of claim 14 wherein said desiccated hydrogel comprises crosslinked polymers of poly(acrylic acid), poly(vinyl alcohol), poly(vinylpyrrolidone), poly(ethylene glycol), or polyacrylamide.

16. The kit of claim 14 wherein said desiccated hydrogel comprises agarose.

17. The kit of claim 13 wherein said expandable gel comprises one or more stains or labeling reagents.
